(19) United States
(12) Patent Application Publication
(10) Pub. No.: US 2010/0040784 A1
(43) Pub. Date: Feb. 18, 2010

(54) Biological method for the treatment of abiotic surfaces

(75) Inventor: Peter Kerstens, Kapellen (BE)

Correspondence Address: STABILPRESS INTERNATIONAL NV, HAACHTSESTEENWEG 1369, BRUSSELS, 1130, BE

(73) Assignee: PETER KERSTENS, KAPELLEN (BE)

(21) Appl. No.: 12/461,440

(22) Filed: Aug. 12, 2009

(30) Foreign Application Priority Data
Aug. 14, 2008 (BE) BE/2008/0453

(51) Int. Cl. B05D 3/00

(52) U.S. Cl. 427/299

(57) ABSTRACT

Method for the preventive treatment of an abiotic surface in a domestic or medical environment, using a watery solution of a mixture with gram-positive non-pathogenic bacteria of the Bacillus genus, by creating a biofilm on the abiotic surface, whereby the application method promotes the hydrophobic interaction and fluid flow.

The present invention concerns a biological method for the preventive treatment of surfaces, by using gram-positive non-pathogenic bacteria of the Bacillus genus. In particular, it concerns a method to apply these non-pathogenic bacteria as a biofilm to an abiotic surface, in order to keep the surface in question free from pathogenic bacteria such as Salmonella, Listeria, E. coli, Staphylococcus, etc.

A well-known method according to the state of the art is to make surfaces bacteria-free by using disinfectants. The use of hydrogen peroxide, which is an oxygen bleach and replaces chlorine-containing products, still has the disadvantage of containing approximately 0.2% phosphonate, which is poorly degradable.

The risk of intensively using chemical disinfectants is that the pathogenic bacteria will show resistance. This will significantly reduce the effect of these substances. In addition, due to mutations, the pathogenic bacteria may adapt to new situations and will thus be more difficult to control.

On the other hand, another well-known method is to use bacteria spores in combination with disinfecting quaternary ammonia and a surfactant to clean hard surfaces in accordance with WO00/63338.

WO97/25865 describes a cleaning formulation with bacteria and a mixture of Proxel, EDTA and IPA.

Another cleaning composition is described in accordance with WO02/33035, consisting of a surfactant, a non-pathogenic bacterium, water, degrading enzymes and an enzyme activator.

FR2855181 in turn consists of a detergent with an antibacterial effect, consisting of bacteria of the Lactobacillus genus with anionic and/or ionic surfactants.

The above-mentioned compositions are aimed at eliminating pathogenic bacteria by cleaning or disinfecting surfaces. Our invention is therefore aimed at keeping pathogenic bacteria such as Salmonella, Listeria, E. coli, Staphylococcus, etc. away from abiotic surfaces in domestic or medical environments, in order to cope with the above-mentioned disadvantages. The creation of a microhabitat of gram-positive non-pathogenic bacteria of the Bacillus genus on an abiotic surface which is to be treated, results in an unfavourable environment for pathogenic and harmful bacteria.

Surfaces are mainly understood to mean places with an increased risk of pathogenic colony formation, consequently involving an increased risk of contamination for man. In addition, it concerns abiotic inert carriers, on which a biofilm of non-pathogenic bacteria is formed. The invention thus exclusively concerns carriers in domestic or medical environments.

The biofilm intended with this invention consists of non-pathogenic gram-positive bacteria of the Bacillus genus, which are generally accepted to be harmless microorganisms (GRAS). These bacteria are applied to the corresponding abiotic surface in a watery solution, using well-known techniques, depending on the surface to be treated.

The first advantage of our invention therefore is that the pathogenic bacteria are not eliminated, but that the environment is deprived of its nutrient medium for these pathogenic bacteria by means of a microhabitat of gram-positive non-pathogenic bacteria, thus significantly reducing the risk of resistance.

Another advantage is that only biological agents are used. This prevents the release of harmful products into the environment, thus avoiding contact with any harmful substances.

Depending on the surface to be treated and the nature of the solution, the solution can be applied with an appropriate dispensing technique, offering a third advantage.

The creation of a biofilm on the surface allows the gram-positive non-pathogenic bacteria to propagate autonomously and quickly, benefiting both the medical and economical value of the invention. This results in a final advantage.

The invention is detailed below.

The invention consists of a method to apply a biofilm on to an abiotic surface. Biofilms are densely packed multi-cellular communities of microorganisms forming on a carrier. Bacillus subtilis is already known to form such biofilms. The cells' aerotaxis promotes the formation of the biofilm on the air/liquid borderline. The use of such biofilms on metals to prevent corrosion is a well-known method in the state of the art.

B. subtilis secretes an extracellular lipopeptide surfactant, i.e. surfactin. This is regulated by means of quorum sensing.

Therefore the biofilm matrix of B. subtilis mainly consists of proteins.

The non-pathogenic bacteria produce a polymer matrix. This extracellular polymer matrix ensures that the resistance of these non-pathogenic bacteria is not affected.

In principle, the creation of the biofilm involves two main steps. A first step consists in bringing the non-pathogenic bacteria and the abiotic surface into contact.

This phase is mainly characterised by non-specific hydrophobic interactions. By bringing a watery solution with gram-positive non-pathogenic bacteria close to the corresponding abiotic surface, preferably <1 μm, they adhere to the surface due to various forces, such as electrostatic forces, van der Waals forces and hydrodynamic forces. On the other hand, the steric hindrance, temperature and charge of both the bacterium and the abiotic surface will play a role. Anyhow, the hydrophobic nature is the most important factor. Husmark U. and Rönner U. (Appl. Bacteriol., 1990 Oct.; 69(4):557-62) have investigated Bacillus cereus spores under various circumstances, such polarity, pH and ionic concentration.

Since the gram-positive non-pathogenic bacteria are contained in a watery solution, chemotaxis is promoted by the fluid, hydrodynamic flow over the abiotic surface.

In a second phase an exopolysaccharide matrix is formed, i.e. the glycocalyx. This is entirely hydrated by the watery solution. In this phase both organic and anorganic molecules are spread in the biofilm.

Since our invention consists of several bacterial strains of the Bacillus genus, the metabolic by-products and the resulting microhabitat will also ensure a better autonomous growth and surface adhesion will also be stimulated by means of ligands.

Quorum sensing allows changes to the behaviour of bacteria, based on the population density. When a so-called “quorum” is achieved, signal molecules indicate that a population change is necessary.

With this invention, quorum sensing is twofold. Non-pathogenic, gram-positive bacteria can quickly expand their population on an inert abiotic carrier, thus creating a biofilm. Pathogenic bacteria will receive a signal that the carrier is unsuited for further habitation and will thus leave the surface.

In other words, it is important to promote the population density of the gram-positive non-pathogenic bacteria on the corresponding abiotic surface as quickly as possible. If this population density with gram-positive non-pathogenic bacteria of the Bacillus genus is sufficiently high, the lack of nutrients is the signal for the pathogenic bacteria not to occupy the corresponding surfaces.

Abiotic surfaces are understood to mean surfaces which are present in both domestic and medical environments. For instance, we are referring to abiotic surfaces made of plastic or surfaces with a plastic coating. Metal abiotic surfaces to which this invention pertains, are exclusively found in domestic or medical environments and concern metal utensils in such environments, for the purpose of keeping these surfaces free from pathogenic, harmful bacteria. For instance, but without any limitation, we are referring to doorknobs, faucets, cabinets, etc. However, these metal surfaces do not involve any risk of corrosion.

The watery solution with the gram-positive non-pathogenic bacteria of the Bacillus genus is applied to the abiotic surface in such a manner that hydrophobic forces between the bacteria and the abiotic surfaces can be achieved. The mixture can be applied by means of atomisation, or fumigation, or by means of a spray, brush, cloth, etc. Atomisation can be achieved automatically, by means of an atomising device located close to the surface to be treated. This may be a pump mechanism or an electronic device with automatic atomisation. However, it is important to bring the non-pathogenic bacteria as close as possible to the surface and also to facilitate a fluid flow.

According to a possible method, the abiotic surface is pretreated with water, until a thin film is created. The watery mixture with non-pathogenic bacteria is subsequently applied. This method facilitates the fluid flow.

The watery solution with a mixture of gram-positive, non-pathogenic bacteria consists of Bacillus amyloliquefaciens, Bacillus subtilis, Bacillus liceniformis, Bacillus pumilis and Bacillus megaterium. These non-pathogenic bacteria are generally considered harmless to man (GRAS)

1. A method to treat an abiotic surface in a domestic or medical environment in order to prevent the formation of a biofilm with pathogenic bacteria, by applying a composition, consisting of an aqueous solution with consortia of non-pathogenic bacteria of the Bacillus genus, without additives and characterised by the fact that the abiotic surface is pretreated with a water film, and that the biofilm is subsequently applied, in a continuous manner, using non-pathogenic bacteria by means of a fluid flow.

2. A method to treat an abiotic surface in a domestic or medical environment in order to prevent the formation of a biofilm with pathogenic bacteria in accordance with claim 1 and characterised by the fact that the composition of non-pathogenic bacteria of the Bacillus genus is applied with an automated dispenser, from a very short distance from the abiotic surface.

3. A method to treat an abiotic surface in a domestic or medical environment in order to prevent the formation of a biofilm with pathogenic bacteria in accordance with claims 1 or 2 and characterised by the fact that the composition is applied through atomisation or with a brush.

4. A method to treat an abiotic surface in a domestic or medical environment in order to prevent the formation of a biofilm with pathogenic bacteria in accordance with claims 1-3 and characterised by the fact that the composition consists of a mixture of Bacillus amyloliquefaciens, Bacillus subtilis, Bacillus liceniformis, Bacillus pumilis and Bacillus megaterium.
